(19) United States
(12) Patent Application Publication
(10) Pub. No.: US 2026/0082147 A1
(43) Pub. Date: Mar. 19, 2026

(54) CONTROL METHOD FOR HEADPHONE, HEADPHONE, AND COMPUTER-READABLE STORAGE MEDIUM

(71) Applicant: SUUNTO SPORTS TECHNOLOGY (DONGGUAN) CO., LTD., Dongguan (CN)

(72) Inventors: Honghao HUANG, Dongguan (CN); Haojia LIAO, Dongguan (CN)

(21) Appl. No.: 19/396,363

(22) Filed: Nov. 21, 2025

Related U.S. Application Data
(63) Continuation of application No. PCT/CN2025/117799, filed on Aug. 29, 2025.

(30) Foreign Application Priority Data
Aug. 30, 2024 (CN) 202411218168.X

(51) Int. Cl. H04R 1/10; A63B 24/00

(52) U.S. Cl. CPC H04R 1/1041; A63B 24/0003; A63B 2208/03; A63B 2220/34; A63B 2220/40; A63B 2220/64; A63B 2230/40; A63B 2244/20; H04R 2460/13

(57) ABSTRACT

Provided is a control method for a headphone. The control method for a headphone includes: enabling a swimming mode of the headphone; obtaining detection data collected by a sensor module; obtaining a swimming parameter of a user wearing the headphone during swimming according to the detection data; and obtaining a swimming stroke of the user during swimming according to the detection data.

### CROSS-REFERENCE TO RELATED APPLICATIONS

This application is a continuation of International Patent Application No. PCT/CN2025/117799, filed on Aug. 29, 2025, which claims priority and interest to Chinese Patent Application No. 202411218168.X, filed on Aug. 30, 2024, both of which are incorporated herein by reference in their entireties.

### FIELD

The present disclosure relates to the technical field of headphone control, and in particular, to a control method for a headphone, a headphone, and a computer-readable storage medium.

### BACKGROUND

As a new smart terminal, a headphone accompanies a user in many activities, such as exercise and rest, and may effectively record an activity trajectory and activity state information of the user.

### SUMMARY

Embodiments of the present disclosure provide a control method for a headphone, a headphone, and a computer-readable storage medium.

The control method for the headphone according to the embodiments of the present disclosure includes: enabling a swimming mode of the headphone; obtaining detection data collected by a sensor module; obtaining a swimming parameter of a user wearing the headphone during swimming according to the detection data; and obtaining a swimming stroke of the user during swimming according to the detection data.

In some embodiments, the control method further includes: issuing prompt information to guide the user to calibrate an attitude of the headphone.

In some embodiments, the sensor module includes a gyroscope. The detection data includes a three-axis angular velocity signal detected by the gyroscope. The control method further includes: determining whether the attitude of the headphone is calibrated successfully; in response to the attitude of the headphone being calibrated successfully, calibrating the three-axis angular velocity signal detected by the gyroscope; and in response to the attitude of the headphone being not calibrated successfully, disabling the swimming mode of the headphone.

In some embodiments, the sensor module further includes an accelerometer, and the detection data includes a three-axis acceleration signal detected by the accelerometer. The determining whether the attitude of the headphone is calibrated successfully includes: fusing the three-axis acceleration signal at each of a plurality of predetermined time points within a predetermined calibration window to obtain a resultant acceleration signal at the plurality of predetermined time points; calculating a maximum value, a minimum value, and an average value of the resultant acceleration signal at the plurality of predetermined time points within the calibration window; and determining whether the attitude of the headphone is calibrated successfully according to the maximum value, the minimum value, and the average value of the resultant acceleration signal.

In some embodiments, the sensor module includes an accelerometer and a gyroscope, and the detection data includes a three-axis acceleration signal detected by the accelerometer and a three-axis angular velocity signal detected by the gyroscope. The obtaining the swimming parameter of the user wearing the headphone during swimming according to the detection data includes: performing complementary filtering and fusion processing on the three-axis acceleration signal and the three-axis angular velocity signal to obtain a resultant acceleration signal, a resultant angular velocity signal, and quaternion data; resolving the quaternion data to obtain an attitude angle signal of the headphone; and determining the swimming parameter according to the resultant acceleration signal, the resultant angular velocity signal, and the attitude angle signal.

In some embodiments, the sensor module includes an accelerometer and a gyroscope, and the detection data includes a three-axis acceleration signal detected by the accelerometer and a three-axis angular velocity signal detected by the gyroscope. The obtaining the swimming parameter of the user wearing the headphone during swimming according to the detection data includes: processing the three-axis acceleration signal and the three-axis angular velocity signal at each of a plurality of predetermined time points within a predetermined swimming window to obtain a resultant acceleration signal, a resultant angular velocity signal, and an attitude angle signal of the headphone at the plurality of predetermined time points within the swimming window; and determining the swimming parameter according to the resultant acceleration signal, the resultant angular velocity signal, and the attitude angle signal.

In some embodiments, the swimming parameter includes a freestyle breathing angle, and the attitude angle signal includes a roll angle signal. The determining the swimming parameter according to the resultant acceleration signal, the resultant angular velocity signal, and the attitude angle signal includes: obtaining a peak maximum value and a trough average value of the resultant acceleration signal and a peak maximum value and a trough average value of the resultant angular velocity signal; and within a first predetermined period, in response to the roll angle signal rising and then falling, and each of the resultant acceleration signal and the resultant angular velocity signal having at least two peak maximum values greater than a first predetermined peak threshold and at least two trough average values smaller than a first predetermined trough threshold, determining a maximum roll angle within the first predetermined period as the freestyle breathing angle.

In some embodiments, the swimming parameter includes a freestyle glide angle, and the attitude angle signal includes a roll angle signal and a pitch angle signal. The determining the swimming parameter according to the resultant acceleration signal, the resultant angular velocity signal, and the attitude angle signal includes: obtaining a peak maximum value and a trough average value of the resultant acceleration signal and a peak maximum value and a trough average value of the resultant angular velocity signal; and within a first predetermined period, in response to a fluctuation amplitude of the roll angle signal being smaller than a predetermined first fluctuation threshold, determining an average pitch angle within the first predetermined period as the freestyle glide angle.

In some embodiments, the swimming parameter includes a breaststroke breathing angle, and the attitude angle signal includes a pitch angle signal. The determining the swimming parameter according to the resultant acceleration signal, the resultant angular velocity signal, and the attitude angle signal includes: obtaining a peak maximum value and a trough average value of the resultant acceleration signal and a peak maximum value and a trough average value of the resultant angular velocity signal; and within a second predetermined period, in response to each of the resultant acceleration signal, the resultant angular velocity signal, and the pitch angle signal rising, determining a current pitch angle as the breaststroke breathing angle.

In some embodiments, the swimming parameter includes a breaststroke glide duration, and the attitude angle signal includes a pitch angle signal. The determining the swimming parameter according to the resultant acceleration signal, the resultant angular velocity signal, and the attitude angle signal includes: obtaining a peak maximum value and a trough average value of the resultant acceleration signal and a peak maximum value and a trough average value of the resultant angular velocity signal; and within a second predetermined period, in response to a fluctuation amplitude of the pitch angle signal being smaller than a predetermined second fluctuation threshold, and the attitude angle signal being within a predetermined breaststroke-glide pitch-angle threshold range, determining a time period during which the pitch angle signal is within the predetermined breaststroke-glide pitch-angle threshold range as the breaststroke glide duration.

In some embodiments, the obtaining the swimming stroke of the user wearing the headphone during swimming according to the detection data includes: obtaining the number of breathing angles within a predetermined swimming window; within the swimming window, in response to each of the resultant acceleration signal and the resultant angular velocity signal having at least two peak average values greater than a first predetermined peak threshold, and the number of breathing angles being greater than a predetermined first number threshold, determining the swimming stroke as freestyle; and within the swimming window, in response to each of the resultant acceleration signal and the resultant angular velocity signal rising, and the number of breathing angles being greater than a predetermined second number threshold, determining the swimming stroke as breaststroke.

In some embodiments, the control method further includes: obtaining standard parameters corresponding to different standard swimming strokes stored in a database; and providing a swimming stroke evaluation or a correction suggestion according to the swimming parameter, the swimming stroke of the user, and the standard parameter.

In some embodiments, the providing the swimming stroke evaluation or the correction suggestion according to the swimming parameter, the swimming stroke of the user, and the standard parameter includes: obtaining a swimming parameter corresponding to a swimming stroke of the user during actual swimming and the standard parameter corresponding to the swimming stroke; and comparing the swimming parameter corresponding to the swimming stroke with the standard parameter corresponding to the swimming stroke, and determining a swimming stroke standardization degree of the swimming stroke of the user.

In some embodiments, the providing the swimming stroke evaluation or the correction suggestion according to the swimming parameter, the swimming stroke of the user, and the standard parameter includes: obtaining a swimming parameter corresponding to a swimming stroke of the user during actual swimming and the standard parameter corresponding to the swimming stroke; comparing the swimming parameter corresponding to the swimming stroke with the standard parameter corresponding to the swimming stroke, to obtain an actual difference; and providing the correction suggestion according to the actual difference.

In some embodiments, the control method further includes: storing a historical swimming parameter and a historical swimming stroke generated by historical swimming of the user as historical swimming data into a personal database of the user; and obtaining a change trend of the swimming parameter of the user according to a current swimming parameter generated by current swimming of the user and the historical swimming parameter.

The present disclosure further provides a headphone. The headphone includes: a sensor module configured to collect detection data; and a control module in a communication connection with the sensor module and configured to execute the control method according to any one of the above embodiments.

In some embodiments, the headphone in the above embodiments is a bone conduction headphone.

The present disclosure further provides a computer-readable storage medium, having a program stored thereon. The program, when executed by a processor, implements the control method according to any one of the above embodiments.

In the control method for a headphone, the headphone, and the computer-readable storage medium provided by the present disclosure, in response to enabling the swimming mode by the headphone, the swimming parameter of the user wearing the headphone and the swimming stroke of the user during swimming are obtained according to the detection data collected by the sensor module, thereby increasing a function of the headphone and expanding an application scenario of the headphone.

Additional aspects and advantages of the present disclosure will be provided in part in the following description, or will become apparent in part from the following description, or can be learned from practicing of the embodiments of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a schematic flowchart of a control method for a headphone according to some embodiments of the present disclosure;

FIG. 2 is a schematic structural diagram of a headphone according to some embodiments of the present disclosure;

FIG. 3 is a schematic flowchart of a control method for a headphone according to other embodiments of the present disclosure;

FIG. 4 is a schematic structural diagram of a headphone according to other embodiments of the present disclosure;

FIG. 5 is a schematic flowchart of determining whether an attitude of a headphone is calibrated successfully in a control method for a headphone according to some embodiments of the present disclosure;

FIG. 6 is a schematic flowchart of obtaining a swimming parameter of a user wearing a headphone during swimming according to detection data in a control method for a headphone according to some embodiments of the present disclosure;

FIG. 7 is a schematic flowchart of determining a swimming parameter according to a resultant acceleration signal, a resultant angular velocity signal, and an attitude angle signal in a control method for a headphone according to some embodiments of the present disclosure;

FIG. 8 is a schematic diagram of a freestyle breathing angle according to some embodiments of the present disclosure;

FIG. 9 is a schematic diagram of a freestyle glide angle according to some embodiments of the present disclosure;

FIG. 10 is a schematic diagram of a breaststroke breathing angle according to some embodiments of the present disclosure;

FIG. 11 is a schematic flowchart of obtaining a swimming stroke of a user wearing a headphone during swimming according to detection data in a control method for a headphone according to some embodiments of the present disclosure;

FIG. 12 is a schematic flowchart of providing a swimming stroke evaluation or a correction suggestion according to a swimming parameter, a swimming stroke of a user, and a standard parameter in a control method for a headphone according to some embodiments of the present disclosure; and

FIG. 13 is a schematic diagram of a connection state between a computer-readable storage medium and a processor according to some embodiments of the present disclosure.

### DETAILED DESCRIPTION

The embodiments of the present disclosure will be further described below with reference to the accompanying drawings. Same or similar elements, or elements having same or similar functions, are denoted by same or similar reference numerals as illustrated in the accompanying drawings.

In addition, the embodiments of the present disclosure described below with reference to the drawings are illustrative only, and are intended to explain the embodiments of the present disclosure, rather than limiting the present disclosure.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

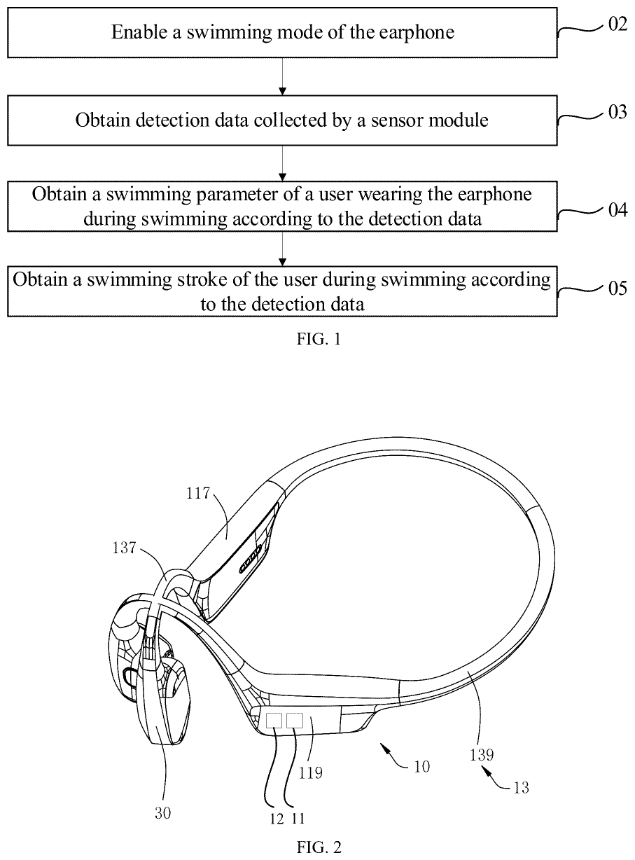

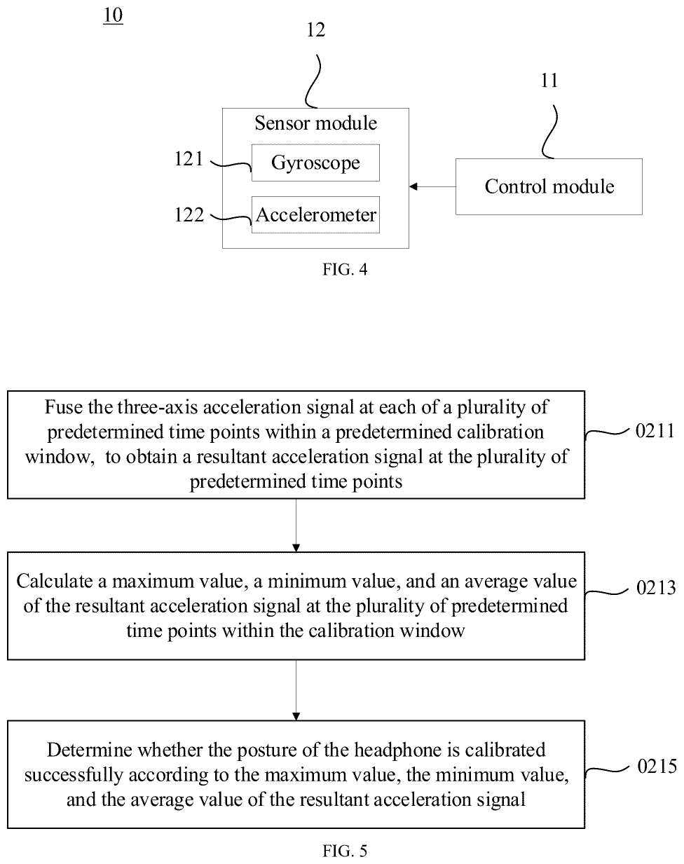

With the development and popularization of portable electronic products and smart terminals, a headphone, as a new smart terminal, accompany a user in many activities, such as exercise and rest, and can effectively record sports data, an activity trajectory, and activity state information of the user. However, current headphones have quite limited functions, and cannot analyze a swimming stroke of the user during swimming or obtain various indexes of the user under different swimming strokes, which limits the application scenario of the headphones. How to solve the problem that the headphones cannot analyze the swimming stroke of the user during swimming and cannot obtain various indexes of the user under different swimming strokes due to their limited functions has become an urgent problem to be solved by those skilled in the art. To solve this problem, the present disclosure provides a control method for a headphone (as shown in FIG. 1), a headphone 10 (as shown in FIG. 2 and FIG. 4), and a computer-readable storage medium 200 (as shown in FIG. 13).

Referring to FIG. 1 and FIG. 2, the control method for a headphone according to some embodiments of the present disclosure includes following steps 02 to 05.

At step 02, a swimming mode of the headphone is enabled.

At step 03, detection data collected by a sensor module 12 is obtained.

At step 04, a swimming parameter of a user wearing the headphone during swimming is obtained according to the detection data.

At step 05, a swimming stroke of the user during swimming is obtained according to the detection data.

The above control method for a headphone is applicable to the headphone 10. The headphone 10 according to some embodiments of the present disclosure includes a control module 11 and a sensor module 12. The control module 11 is configured to: enable the swimming mode; obtain the detection data collected by the sensor module 12; obtain the swimming parameter of the user wearing the headphone during swimming according to the detection data; and obtain the swimming stroke of the user during swimming according to the detection data.

The headphone 10 is an audio device mainly used for sound-electrical conversion. For example, the headphone 10 converts an audio signal into sound, enabling the user to listen to music, movies, games, or other audio content, or converts the sound into an electrical signal. The headphone 10 is designed to provide a private listening environment, allowing the user to enjoy audio content alone without disturbing others around. In the present disclosure, the headphone 10 is provided with functions of analyzing the swimming stroke of the user wearing the headphone and measuring various indexes of the user wearing the headphone under different swimming strokes. For this purpose, the headphone 10 needs to have the function of monitoring and recording various data during swimming, and also needs to have a strong waterproof capability such that the headphone 10 can be completely submerged in water and used underwater for a long time, to ensure that the headphone 10 can collect various detection data and determine the swimming parameter and the swimming stroke when the user wearing the headphone swims for a long time. The headphone 10 in the present disclosure may be a bone conduction headphone that transmits sound by using bones of a human body instead of traditional sound waves transmitted through the air. When worn by the user, the bone conduction headphone does not block the ears. Compared with an in-ear earphone, the bone conduction headphone can avoid hearing damage caused by long-term use, while ensuring that the user is able to hear external sounds when using the bone conduction headphone, improving safety of outdoor sports of the user. Therefore, in the present disclosure, the headphone 10 may be a bone conduction headphone including a storage module.

In an embodiment, the headphone 10 includes a control module 11 and a sensor module 12. The control module 11 may be connected with the sensor module 12 through a wired communication connection formed by a data line, or through a wireless communication connection formed by a wireless signal. In the control method for headphone according to the present disclosure, steps 02, 03, 04, and 05 are executed by the control module 11. The control module 11 is arranged inside the headphone 10 and is responsible for processing various data and coordinating various functions (including, but not limited to, audio processing, device connection, power management, user interaction, and other functions). In the present disclosure, the control module 11 is used for the user wearing the headphone to select a mode of the headphone 10, and for obtaining the swimming parameter and the swimming stroke of the user during swimming according to the detection data obtained by the sensor module 12. The sensor module 12 provides additional functional support for the headphone 10, and is a module in the headphone 10 that obtains external information and/or a parameter of the headphone 10. The sensor module 12 may be an accelerometer (configured to detect a three-axis acceleration of the headphone 10), a gyroscope (configured to detect a three-axis angular velocity of the headphone 10), a magnetometer (also referred to as a compass sensor, and configured to detect a direction of the Earth's magnetic field to help the headphone 10 to determine its own orientation, which is very important for positioning and navigation applications of the headphone 10), a heart rate sensor (configured to measure a heart rate of the user through skin contact), and a pressure sensor (configured to detect a pressure exerted by the user on the headphone when wearing the headphone, which can be used to adjust a volume, control playback, answer calls, or perform other functions). In the present disclosure, the sensor module 12 is configured to collect various data of the user wearing the headphone 10 during swimming, to assist the control module 11 in obtaining the swimming parameter and the swimming stroke of the user during swimming.

In an embodiment, referring to FIG. 2, the headphone 10 further includes a battery compartment 117 for placing a battery and/or a control box 119 with a control function. The control box 119 may be configured to control power-on and power-off of the headphone 10 and adjust a volume of the headphone 10. In an embodiment, the control box 119 includes a first box body, a control module 11, and a sensor module 12. The control module 11 and the sensor module 12 may be mounted in the first box body. The battery compartment 117 includes a second box body and a battery. The battery is mounted in the second box body, and is used to supply power to the headphone 10, enabling the headphone 10 to operate normally.

In an embodiment, the headphone 10 further includes a to-be-connected part 13 including an ear hook 137 and/or a rear headband 139. When the headphone is worn by the user, the rear headband 139 of the headphone 10 is worn on the head, and the ear hook 137 of the headphone 10 is worn behind the ear, which can improve wearing stability of the headphone 10. Even when the user is outdoors or exercising, the headphone 10 is not easy to fall off. The rear headband 139 is configured to connect the battery compartment 117 and the control box 119. The headphone 10 further includes a transducer assembly 30. The ear hook 137 is configured to connect the battery compartment 117 and the transducer assembly 30, and to connect the control box 119 and the transducer assembly 30. The transducer assembly 30 is configured to be in contact with the skin of the user. When the headphone 10 is in use, the transducer assembly 30 may generate mechanical vibrations to allow the user to hear sound.

In an embodiment, in steps 02 and 03, the user wearing the headphone 10 may enable the swimming mode of the headphone 10 through the control module 11, and control the sensor module 12 to collect detection data related to swimming of the user. In step 04, the control module 11 obtains the swimming parameter of the user during swimming based on the detection data. In an embodiment, the swimming parameter includes a real-time freestyle breathing angle, a real-time freestyle glide angle, a real-time breaststroke breathing angle, a real-time breaststroke glide duration, a breathing frequency, a freestyle breathing angle, a maximum freestyle breathing angle, a freestyle pitch angle, a breaststroke breathing angle, a maximum breaststroke breathing angle, a total breaststroke glide duration, a total freestyle duration, and a total breaststroke duration. The breathing angle refers to a position and direction of the head relative to a water surface when the head is above the water surface for breathing during swimming. Therefore, maintaining a correct breathing angle during swimming is crucial for the user to maintain body balance, improve swimming efficiency, and avoid choking on water. The pitch angle usually refers to f a body posture of a swimmer under water and a change in an angle of a head position of the swimmer relative to the water surface. Therefore, maintaining a good pitch angle during swimming is crucial for the user to improve the swimming efficiency, reduce resistance, maintain a correct breathing mode, and enhance overall performance. The glide angle refers to an angle between the head of the user and a vertical plane during swimming. An ideal glide angle can help the user to reduce water resistance and improve the swimming efficiency. In step 05, while obtaining the swimming parameter of the user during swimming based on the detection data, the control module 11 may further determine a type of the swimming stroke of the user. The swimming stroke includes, but is not limited to, freestyle, breaststroke, backstroke, and butterfly stroke. The control module 11 may determine a proportion of each swimming stroke based on the type of the swimming stroke and the swimming parameter.

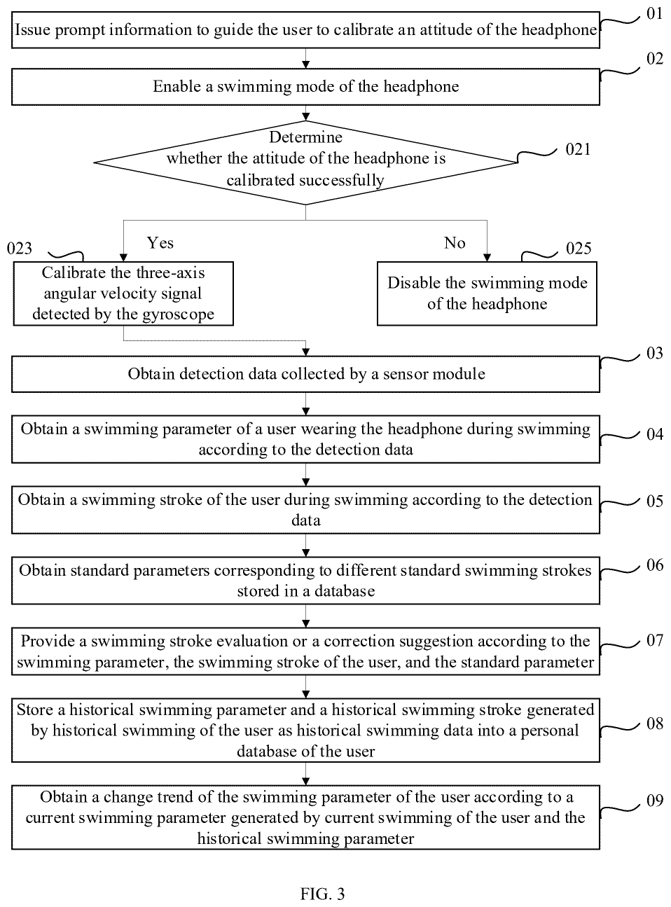

In some embodiments, referring to FIG. 2 and FIG. 3, the control method of the present disclosure further includes following step 01.

At step 01, prompt information is issued to guide the user to calibrate an attitude of the headphone 10.

The above control method for headphone is applicable to the headphone 10. The control module 11 is further configured to issue the prompt information to guide the user to calibrate the attitude of the headphone 10.

It can be understood that in some embodiments, before the sensor module 12 is controlled to collect data, the prompt information may first be issued to the user to guide the user to calibrate the attitude of the headphone 10. In an embodiment, the control module 11 guides the user to look straight ahead through a voice prompt or a vibration prompt from a vibrator, to determine a reference angle in a subsequent attitude angle detection process, thereby realizing the attitude calibration of the headphone 10 and ensuring accuracy of an attitude angle collected in subsequent steps.

Referring to FIG. 3 and FIG. 4, in some embodiments, the sensor module 12 includes a gyroscope 121, and the detection data includes a three-axis angular velocity signal detected by the gyroscope 121. The control method of the present disclosure further includes following steps 021 to 025.

At step 021, it is determined whether the attitude of the headphone 10 is calibrated successfully.

At step 023, in response to the attitude of the headphone 10 being calibrated successfully, the three-axis angular velocity signal detected by the gyroscope 121 is calibrated.

At step 025, in response to the attitude of the headphone 10 being not calibrated successfully, the swimming mode of the headphone is disabled.

The above control method for a headphone is applicable to the headphone 10. The control module 11 is further configured to: determine whether the attitude of the headphone 10 is calibrated successfully; in response to the attitude of the headphone 10 being calibrated successfully, calibrate the three-axis angular velocity signal detected by the gyroscope 121; and in response to the attitude of the headphone 10 being not calibrated successfully, disable the swimming mode of the headphone 10.

In an embodiment, in step 021, after the swimming mode of the headphone 10 is enabled, it is required to ensure the accuracy of detection data collected by the sensor module 12 before the control module 11 controls the sensor module 12 to collect detection data. Therefore, the control module 11 first determines whether the attitude of the headphone 10 is calibrated successfully. In steps 023 and 025, in response to the attitude of the headphone 10 being calibrated successfully, the control module 11 proceeds to the subsequent steps, i.e., calibrating the three-axis angular velocity signal detected by the gyroscope 121 to further ensure the accuracy of the three-axis angular velocity signal measured by the gyroscope 121. However, in response to the attitude of the headphone 10 being not calibrated successfully, the control module 11 needs to control the headphone 10 to disable the swimming mode. After the user wearing the headphone recalibrates the attitude of the headphone 10 and enables the swimming mode, it is re-determined whether the attitude of the headphone 10 is calibrated successfully.

In some embodiments, referring to FIG. 4 and FIG. 5, step 021 includes following steps 0211 to 0215.

At step 0211, the three-axis acceleration signal is fused at each of a plurality of predetermined time points within a predetermined calibration window, to obtain a resultant acceleration signal at the plurality of predetermined time points.

At step 0213, a maximum value, a minimum value, and an average value of the resultant acceleration signal at the plurality of predetermined time points within the calibration window are calculated.

At step 0215, it is determined whether the attitude of the headphone is calibrated successfully according to the maximum value, the minimum value, and the average value of the resultant acceleration signal.

The above control method for a headphone is applicable to the headphone 10. The control module 11 is further configured to: fuse the three-axis acceleration signal at each of the plurality of predetermined time points within the predetermined calibration window, to obtain the resultant acceleration signal at the plurality of predetermined time points; calculate the maximum value, the minimum value, and the average value of the resultant acceleration signal at the plurality of predetermined time points within the calibration window; and determine whether the attitude of the headphone is calibrated successfully according to the maximum value, the minimum value, and the average value of the resultant acceleration signal.

In an embodiment, in step 0211, the predetermined calibration window may be a time window set in advance by the user, or a time window predetermined for the headphone 10 based on empirical values before leaving the factory. The control module 11 obtains the swimming parameter and the swimming stroke of the user during swimming based on the detection data collected by the sensor module 12 within this time window. Therefore, before the detection data is collected, the control module 11 needs to fuse the three-axis acceleration signal at each of the plurality of predetermined time points within the predetermined calibration window, to obtain the resultant acceleration signal at the plurality of predetermined time points. Compared with a single-axis acceleration signal, the resultant acceleration signal reflects the attitude of the headphone 10 more accurately. In steps 0213 and 0215, the control module 11 calculates the maximum value, the minimum value, and the average value of the resultant acceleration signal at the plurality of predetermined time points within the calibration window, to determine whether the attitude of the headphone 10 is calibrated successfully according to the maximum value, the minimum value, and the average value of the resultant acceleration signal. In an embodiment, the headphone 10 stores a resultant acceleration calibration threshold for determining whether the attitude of the headphone 10 is calibrated successfully. The resultant acceleration calibration threshold includes a maximum resultant acceleration calibration threshold, a minimum resultant acceleration calibration threshold, and an average resultant acceleration calibration threshold range. Within the calibration window, in response to the maximum value of the resultant acceleration signal being smaller than the maximum resultant acceleration calibration threshold, the minimum value of the resultant acceleration signal being greater than the minimum resultant acceleration calibration threshold, and the average value of the resultant acceleration signal being within the average resultant acceleration calibration threshold range, it is determined that the attitude of the headphone 10 conforms to a characteristic that the user wearing the headphone 10 looks straight ahead and remains still. At this time, it is determined that the attitude of the headphone 10 is calibrated successfully. Within the calibration window, in response to the maximum value of the resultant acceleration signal being greater than the maximum resultant acceleration calibration threshold, or the minimum value of the resultant acceleration signal being smaller than the minimum resultant acceleration calibration threshold, or the average value of the resultant acceleration signal being not within the average resultant acceleration calibration threshold range, it is determined that the attitude of the headphone 10 does not conform to the characteristic that the user wearing the headphone 10 looks straight ahead and remains still. At this time, it is determined that the attitude of the headphone 10 is not calibrated successfully.

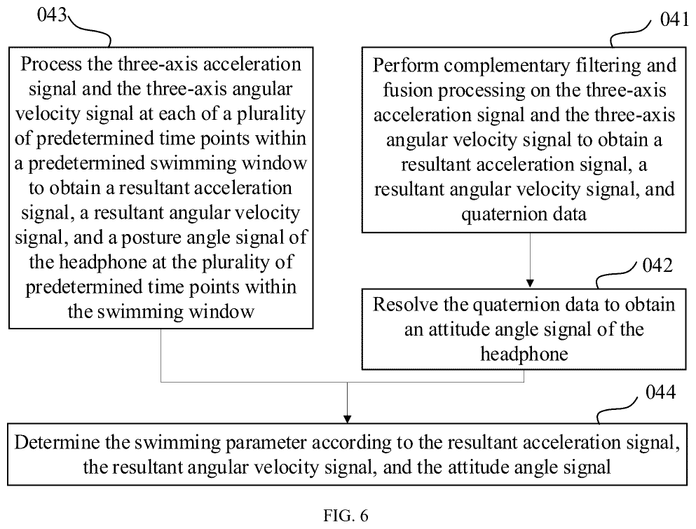

Referring to FIG. 4 and FIG. 6, in some embodiments, the sensor module 12 includes an accelerometer 122 and a gyroscope 121. The detection data includes a three-axis acceleration signal detected by the accelerometer 122 and a three-axis angular velocity signal detected by the gyroscope 121. Step 04 includes following steps 041 to 044.

At step 041, complementary filtering and fusion processing is performed on the three-axis acceleration signal and the three-axis angular velocity signal to obtain a resultant acceleration signal, a resultant angular velocity signal, and quaternion data.

At step 042, the quaternion data is resolved to obtain an attitude angle signal of the headphone.

At step 044, the swimming parameter is determined according to the resultant acceleration signal, the resultant angular velocity signal, and the attitude angle signal.

The above control method for a headphone is applicable to the headphone 10. The control module 11 is further configured to: perform the complementary filtering and fusion processing on the three-axis acceleration signal and the three-axis angular velocity signal to obtain the resultant acceleration signal, the resultant angular velocity signal, and the quaternion data; resolve the quaternion data to obtain the attitude angle signal of the headphone; and determine the swimming parameter according to the resultant acceleration signal, the resultant angular velocity signal, and the attitude angle signal.

In an embodiment, in step 041, the control module 11 performs filtering and fusion on the three-axis acceleration signal and the three-axis angular velocity signal. Noise in the signals is eliminated through the filtering to further ensure accuracy of the three-axis acceleration signal and the three-axis angular velocity signal. Meanwhile, fusion processing is respectively performed on the three-axis acceleration signal and the three-axis angular velocity signal, to obtain the resultant acceleration signal and the resultant angular velocity signal. Compared with a single-axis acceleration signal or a single-axis angular velocity signal, the resultant acceleration signal and the resultant angular velocity signal reflects the attitude of the headphone 10 more comprehensively. Referring to step 042, the control module 11 further performs the complementary filtering and fusion processing on the three-axis acceleration signal and the three-axis angular velocity signal to obtain the quaternion data, which includes one real part and three imaginary parts, and is a mathematical concept capable of representing rotation and a direction in a three-dimensional space. By resolving the quaternion data, the control module 11 can obtain the attitude angle signal used to reflect the attitude of the headphone 10. Then, in step 044, the swimming parameter is determined according to the resultant acceleration signal, the resultant angular velocity signal, and the attitude angle signal.

Referring to FIG. 4 and FIG. 6, in some embodiments, the sensor module 12 includes an accelerometer 122 and a gyroscope 121. The detection data includes a three-axis acceleration signal detected by the accelerometer 122 and a three-axis angular velocity signal detected by the gyroscope 121. Step 04 further includes following steps 043 and 044.

At step 043, the three-axis acceleration signal and the three-axis angular velocity signal are processed at each of a plurality of predetermined time points within a predetermined swimming window to obtain a resultant acceleration signal, a resultant angular velocity signal, and an attitude angle signal of the headphone at the plurality of predetermined time points within the swimming window.

At step 044, the swimming parameter is determined according to the resultant acceleration signal, the resultant angular velocity signal, and the attitude angle signal.

The above control method for the headphone is applicable to the headphone 10. The control module 11 is further configured to: process the three-axis acceleration signal and the three-axis angular velocity signal at each of the plurality of predetermined time points within the predetermined swimming window to obtain the resultant acceleration signal, the resultant angular velocity signal, and the attitude angle signal of the headphone at the plurality of predetermined time points within the swimming window; and determine the swimming parameter according to the resultant acceleration signal, the resultant angular velocity signal, and the attitude angle signal.

It can be understood that when the sensor module 12 has high collection performance, the three-axis acceleration signal and the three-axis angular velocity signal may be used directly without filtering, i.e., the control module 11 directly processes the three-axis acceleration signal and the three-axis angular velocity signal at each of the plurality of predetermined time points within the predetermined swimming window to obtain the resultant acceleration signal, the resultant angular velocity signal, and the attitude angle signal of the headphone at the plurality of predetermined time points within the swimming window, and then determines the swimming parameter according to the resultant acceleration signal, the resultant angular velocity signal, and the attitude angle signal.

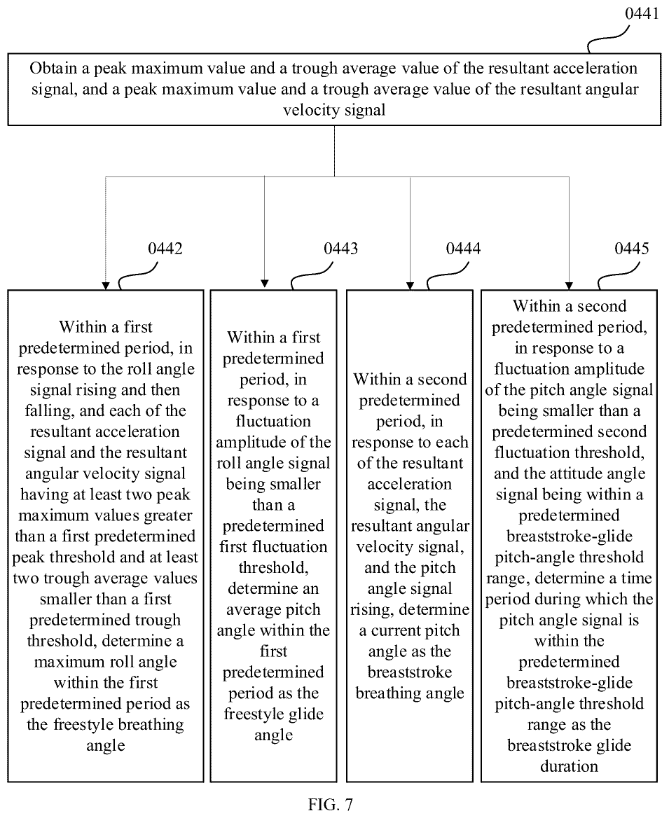

Referring to FIG. 4 and FIG. 7, in some embodiments, the swimming parameter includes a freestyle breathing angle. The attitude angle signal includes a roll angle signal. Step 044 includes following steps 0441 and 0442.

At step 0441, a peak maximum value and a trough average value of the resultant acceleration signal, and a peak maximum value and a trough average value of the resultant angular velocity signal are obtained.

At step 0442, within a first predetermined period, in response to the roll angle signal rising and then falling, and each of the resultant acceleration signal and the resultant angular velocity signal having at least two peak maximum values greater than a first predetermined peak threshold and at least two trough average values smaller than a first predetermined trough threshold, a maximum roll angle within the first predetermined period is determined as the freestyle breathing angle.

The above control method for a headphone is applicable to the headphone 10. The control module 11 is further configured to: obtain the peak maximum value and the trough average value of the resultant acceleration signal, and the peak maximum value and the trough average value of the resultant angular velocity signal; and determine, within the first predetermined period, in response to the roll angle signal rising and then falling, and each of the resultant acceleration signal and the resultant angular velocity signal having the at least two peak maximum values greater than the first predetermined peak threshold and the at least two trough average values smaller than the first predetermined trough threshold, the maximum roll angle within the first predetermined period as the freestyle breathing angle.

In an embodiment, the roll angle signal is calculated through the following equation:

$$Roll = a tan 2 ( 2 * q 2 * q 3 + 2 * q 0 * q 1 , - 2 * q 1 * q 1 - 2 * q 2 * q 2 ) .$$

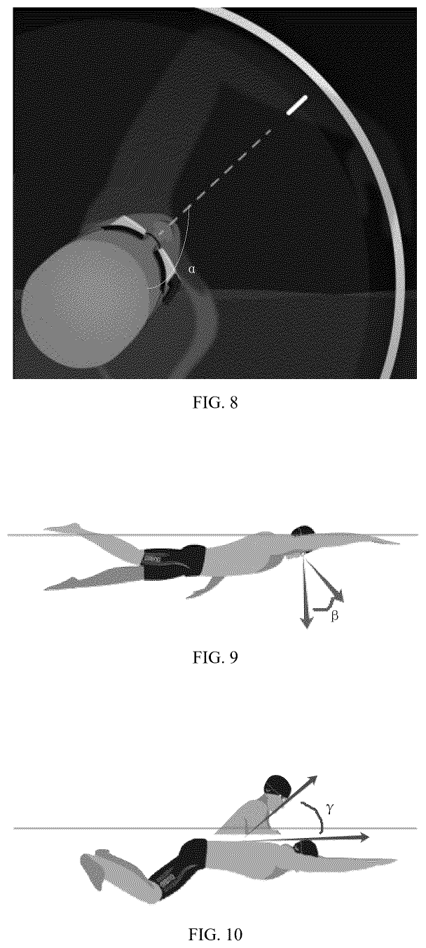

In the above equation, q0, q1, q2, and q3 are the quaternion data, and Roll is a roll angle. In step 0441, the swimming parameter needs to be obtained based on the peak maximum value and the trough average value of the resultant acceleration signal, and the peak maximum value and the trough average value of the resultant angular velocity signal. In an embodiment, in step 0442, the first predetermined period is a signal detection period predetermined inside the headphone 10. Within the first predetermined period, in response to the roll angle signal rising and then falling, and each of the resultant acceleration signal and the resultant angular velocity signal having the at least two peak maximum values greater than the first predetermined peak threshold and the at least two trough average values smaller than the first predetermined trough threshold, the control module 11 determines the maximum roll angle within the first predetermined period as the freestyle breathing angle. Referring to FIG. 8, angle α in FIG. 8 is the breathing angle. The breathing angle refers to the position and direction of the head relative to the water surface when the head is above the water for breathing during swimming. Therefore, the breathing angle may be determined by the roll angle.

Referring to FIG. 4 and FIG. 7, in some embodiments, the swimming parameter includes a freestyle glide angle. The attitude angle signal includes a roll angle signal and a pitch angle signal. Step 044 includes following steps 0441 and 0443.

At step 0441, a peak maximum value and a trough average value of the resultant acceleration signal, and a peak maximum value and a trough average value of the resultant angular velocity signal are obtained.

At step 0443, within a first predetermined period, in response to a fluctuation amplitude of the roll angle signal being smaller than a predetermined first fluctuation threshold, an average pitch angle within the first predetermined period is determined as the freestyle glide angle.

The above control method for a headphone is applicable to the headphone 10. The control module 11 is further configured to: obtain the peak maximum value and the trough average value of the resultant acceleration signal, and the peak maximum value and the trough average value of the resultant angular velocity signal; and determine, within the first predetermined period, in response to the fluctuation amplitude of the roll angle signal being smaller than the predetermined first fluctuation threshold, the average pitch angle within the first predetermined period as the freestyle glide angle.

In an embodiment, the pitch angle signal is calculated through the following equation:

$$Pitch = a sin ( - 2 * q 1 * q 3 + 2 * q 0 * q 2 ) .$$

In the above equation, q0, q1, q2, and q3 are the quaternion data, and Pitch is a pitch angle. In step 0441, the swimming parameter needs to be obtained based on the peak maximum value and the trough average value of the resultant acceleration signal, and the peak maximum value and the trough average value of the resultant angular velocity signal. In an embodiment, in step 0443, the first predetermined period is a signal detection period predetermined inside the headphone 10. Within the first predetermined period, in response to the fluctuation amplitude of the roll angle signal being smaller than the predetermined first fluctuation threshold, the control module 11 determines the average pitch angle within the first predetermined period as the freestyle glide angle. Referring to FIG. 9, angle β is the glide angle. The glide angle refers to the angle between the user's head and the vertical plane during swimming. The ideal glide angle helps the user to reduce the water resistance and improve the swimming efficiency. Therefore, the glide angle may be determined by the roll angle and the pitch angle.

Referring to FIG. 4 and FIG. 7, in some embodiments, the swimming parameter includes a breaststroke breathing angle. The attitude angle signal includes a pitch angle signal. Step 044 includes at the following steps 0441 and 0444.

At step 0441, a peak maximum value and a trough average value of the resultant acceleration signal, and a peak maximum value and a trough average value of the resultant angular velocity signal are obtained.

At step 0444, within a second predetermined period, in response to each of the resultant acceleration signal, the resultant angular velocity signal, and the pitch angle signal rising, a current pitch angle is determined as the breaststroke breathing angle.

The above control method for a headphone is applicable to the headphone 10. The control module 11 is further configured to: obtain the peak maximum value and the trough average value of the resultant acceleration signal, and the peak maximum value and the trough average value of the resultant angular velocity signal; and determine, within the second predetermined period, in response to each of the resultant acceleration signal, the resultant angular velocity signal, and the pitch angle signal rising, the current pitch angle as the breaststroke breathing angle.

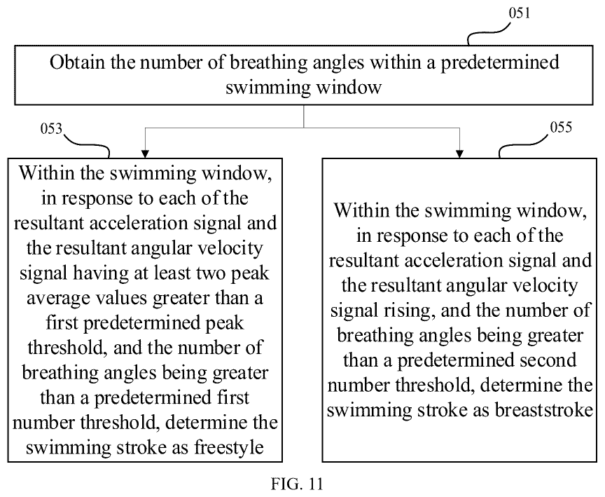

In an embodiment, in step 0441, the swimming parameter needs to be obtained based on the peak maximum value and the trough average value of the resultant acceleration signal and the peak maximum value and the trough average value of the resultant angular velocity signal. In an embodiment, in step 0444, the second predetermined period is a signal detection period predetermined inside the headphone 10. Referring to FIG. 10, where angle γ is the breaststroke breathing angle, within the second predetermined period, in response to each of the resultant acceleration signal, the resultant angular velocity signal, and the pitch angle signal rising, it is determined that the head of the user wearing the headphone is lifting relative to the water surface, which indicates a breathing action during breaststroke. The control module 11 determines the current pitch angle as the breaststroke breathing angle.

Referring to FIG. 4 and FIG. 7, in some embodiments, the swimming parameter includes a breaststroke glide duration. The attitude angle signal includes a pitch angle signal. Step 044 includes following steps 0441 and 0445.

At step 0441, a peak maximum value and a trough average value of the resultant acceleration signal, and a peak maximum value and a trough average value of the resultant angular velocity signal are obtained.

At step 0445, within a second predetermined period, in response to a fluctuation amplitude of the pitch angle signal being smaller than a predetermined second fluctuation threshold, and the attitude angle signal being within a predetermined breaststroke-glide pitch-angle threshold range, a time period during which the attitude angle signal is within the predetermined breaststroke-glide pitch-angle threshold range is determined as the breaststroke glide duration.

The above control method for a headphone is applicable to the headphone 10. The control module 11 is further configured to: obtain the peak maximum value and the trough average value of the resultant acceleration signal, and the peak maximum value and the trough average value of the resultant angular velocity signal; and determine, within the second predetermined period, in response to the fluctuation amplitude of the pitch angle signal being smaller than the predetermined second fluctuation threshold, and the attitude angle signal being within the predetermined breaststroke-glide pitch-angle threshold range, the time period during which the pitch angle signal is within the predetermined breaststroke-glide pitch-angle threshold range as the breaststroke glide duration.

In an embodiment, in step 0441, the swimming parameter needs to be obtained based on the peak maximum value and the trough average value of the resultant acceleration signal and the peak maximum value and the trough average value of the resultant angular velocity signal. In an embodiment, in step 0445, the second predetermined period is a signal detection period predetermined inside the headphone 10. Within the second predetermined period, in response to the fluctuation amplitude of the pitch angle signal being smaller than the predetermined second fluctuation threshold, and the attitude angle signal being within the predetermined breaststroke-glide pitch-angle threshold range, it is determined that the head of the user wearing the headphone is below the water surface and the user is looking at the bottom of the water, i.e., the user wearing the headphone is in an underwater glide phase of non-breathing movement during breaststroke. The control module 11 determines the time period during which the pitch angle signal is within the predetermined breaststroke-glide pitch-angle threshold range as the breaststroke glide duration.

Referring to FIG. 4 and FIG. 11, in some embodiments, step 05 includes following steps 051 to 055.

At step 051, the number of breathing angles within a predetermined swimming window is obtained.

At step 053, within the swimming window, in response to each of the resultant acceleration signal and the resultant angular velocity signal having at least two peak average values greater than a first predetermined peak threshold, and the number of breathing angles being greater than a predetermined first number threshold, the swimming stroke is determined as freestyle.

At step 055, within the swimming window, in response to each of the resultant acceleration signal and the resultant angular velocity signal rising, and the number of breathing angles being greater than a predetermined second number threshold, the swimming stroke is determined as breaststroke.

The above control method for a headphone is applicable to the headphone 10. The control module 11 is further configured to: obtain the number of breathing angles within the predetermined swimming window; determine, within the swimming window, in response to each of the resultant acceleration signal and the resultant angular velocity signal having at least two peak average values greater than the first predetermined peak threshold, and the number of breathing angles being greater than the predetermined first number threshold, the swimming stroke as the freestyle; and determine, within the swimming window, in response to each of the resultant acceleration signal and the resultant angular velocity signal rising, and the number of breathing angles being greater than the predetermined second number threshold, the swimming stroke as the breaststroke.

In an embodiment, since different swimming strokes have different breathing frequencies, before the swimming stroke is determined, the control module 11 obtains the number of breathing angles within the predetermined swimming window, i.e., determines the number of breathing times through the number of breathing angles, and then determines the breathing frequency. In steps 053 and 055, within the swimming window, in response to each of the resultant acceleration signal and the resultant angular velocity signal having the at least two peak average values greater than the first predetermined peak threshold, and the number of breathing angles being greater than the predetermined first number threshold, it is determined that the resultant acceleration signal and the resultant angular velocity signal conform to the attitude characteristic of the freestyle stroke, a current breathing frequency of the user conforms to the breathing characteristic of the freestyle stroke, so the control module 11 determines the swimming stroke as the freestyle. Within the swimming window, in response to each of the resultant acceleration signal and the resultant angular velocity signal rising, and the number of breathing angles being greater than the predetermined second number threshold, it is determined that the resultant acceleration signal and the resultant angular velocity signal conform to the attitude characteristic of the breaststroke, and a current breathing frequency of the user conforms to the breathing characteristic of the breaststroke, so the control module 11 determines the swimming stroke as the breaststroke. In addition, in response to the resultant acceleration signal or the resultant angular velocity signal not satisfying the above condition, or the breathing frequency not satisfying the above condition, the control module 11 determines the swimming stroke as another swimming stroke, such as butterfly stroke or backstroke.

In some embodiments, the swimming parameter includes a freestyle breathing angle, a freestyle glide angle, a breaststroke breathing angle, a breaststroke glide duration, a breathing frequency, a maximum freestyle breathing angle, a freestyle pitch angle, a maximum breaststroke breathing angle, a total breaststroke glide duration, a total freestyle duration, and a total breaststroke duration.

It can be understood that through the above embodiments, the swimming stroke, the freestyle breathing angle, the freestyle glide angle, the breaststroke breathing angle, the breaststroke glide duration, and the breathing frequency of the user during swimming may be determined. The maximum freestyle breathing angle or the maximum breaststroke breathing angle is a maximum value between freestyle breathing angles or breaststroke breathing angles within a predetermined swimming time window. The freestyle pitch angle may be directly determined through the pitch angle signal. In addition, since the swimming process consists of a glide process and a breathing process, the total glide duration and the total freestyle duration or the total breaststroke duration can be directly determined through a signal curve, thereby determining a proportion of the freestyle or breaststroke.

Referring to FIG. 3 and FIG. 4, in some embodiments, the control method of the present disclosure further includes following steps 06 and 07.

At step 06, standard parameters corresponding to different standard swimming strokes stored in a database are obtained.

At step 07, a swimming stroke evaluation or a correction suggestion is provided according to the swimming parameter and the swimming stroke of the user, and the standard parameters.

The above control method for a headphone is applicable to the headphone 10. The control module 11 is further configured to: obtain the standard parameters corresponding to the different standard swimming strokes stored in the database; and provide the swimming stroke evaluation or the correction suggestion according to the swimming parameter and the swimming stroke of the user, and the standard parameter.

In an embodiment, the database contains the standard parameters of different standard swimming strokes. After obtaining the swimming parameter and the swimming stroke of the user, the control module 11 compares the swimming parameter of the user under the corresponding stroke with a standard parameter, to obtain an evaluation of user's current swimming and a correction suggestion for this swimming stroke.

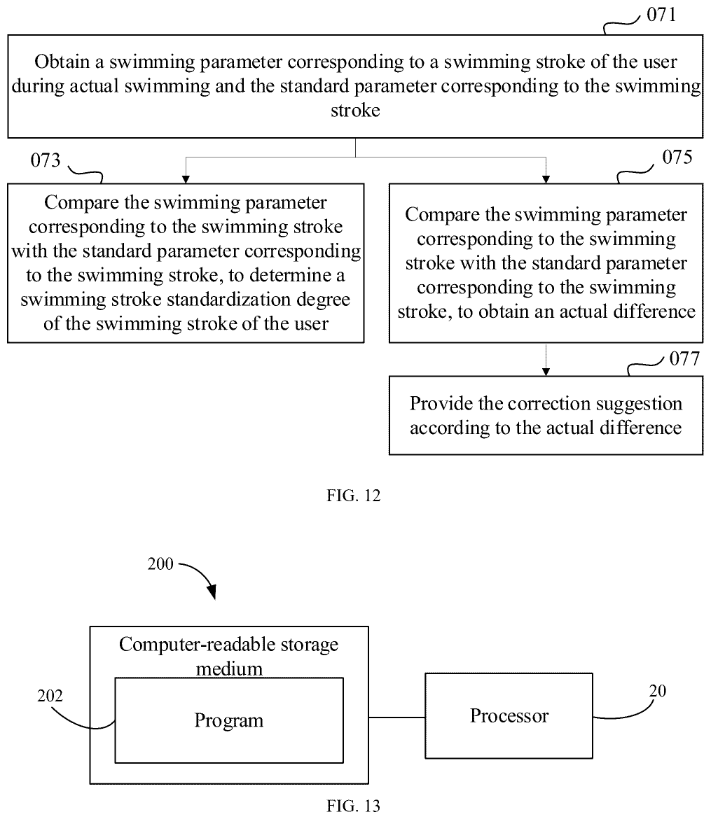

Referring to FIG. 4 and FIG. 12, in some embodiments, step 07 includes following steps 071 and 073.

At step 071, a swimming parameter corresponding to a swimming stroke of the user during actual swimming and the standard parameter corresponding to the swimming stroke are obtained.

At step 073, the swimming parameter corresponding to the swimming stroke is compared with the standard parameter corresponding to the swimming stroke, to determine a swimming stroke standardization degree of the swimming stroke of the user.

The above control method for a headphone is applicable to the headphone 10. The control module 11 is further configured to: obtain the swimming parameter corresponding to the swimming stroke of the user during actual swimming and the standard parameter corresponding to the swimming stroke; and compare the swimming parameter corresponding to the swimming stroke with the standard parameter corresponding to the swimming stroke, to determine the swimming stroke standardization degree of the swimming stroke of the user.

In an embodiment, the swimming stroke standardization degree of the swimming stroke of the user is determined by comparing the swimming parameter corresponding to the swimming stroke of the user during actual swimming with the standard parameter corresponding to the swimming stroke.

Referring to FIG. 4 and FIG. 12, in some embodiments, step 07 includes following steps 071 to 077.

At step 071, a swimming parameter corresponding to a swimming stroke of the user during actual swimming and the standard parameter corresponding to the swimming stroke are obtained.

At step 075, the swimming parameter corresponding to the swimming stroke is compared with the standard parameter corresponding to the swimming stroke, to obtain an actual difference.

At step 077, the correction suggestion is provided according to the actual difference.

The above control method for a headphone is applicable to the headphone 10. The control module 11 is further configured to: obtain the swimming parameter corresponding to the swimming stroke of the user during actual swimming and the standard parameter corresponding to the swimming stroke; compare the swimming parameter corresponding to the swimming stroke with the standard parameter corresponding to the swimming stroke to obtain the actual difference; and provide the correction suggestion according to the actual difference.

In an embodiment, by comparing the swimming parameter corresponding to the swimming stroke of the user during actual swimming with the standard parameter corresponding to the swimming stroke, a difference between the two parameters, i.e., the actual difference in step 075 is obtained. In this way, quantification of the difference between the swimming stroke of the user during actual swimming and the standard swimming stroke is realized, and the correction suggestion is further provided based on this actual difference. For example, in response to the freestyle breathing angle and pitch angle of the user are greater than the standard breathing angle and the standard pitch angle of the freestyle stroke, it is determined that the user has not mastered the most effective force application skills during current freestyle breathing and glide. The headphone 10 issues the correction suggestion to the user through voice or a display screen, thereby helping the user to correct his or her own freestyle stroke.

Referring to FIG. 3 and FIG. 4, in some embodiments, the control method of the present disclosure further includes following steps 08 and 09.

At step 08, a historical swimming parameter and a historical swimming stroke generated by historical swimming of the user are stored as historical swimming data into a personal database of the user.

At step 09, a change trend of the swimming parameter of the user is obtained according to a current swimming parameter generated by current swimming of the user and the historical swimming parameter.

The above control method for a headphone is applicable to the headphone 10. The control module 11 is further configured to: store the historical swimming parameter and the historical swimming stroke generated by the historical swimming of the user as the historical swimming data into the personal database of the user; and obtain the change trend of the swimming parameter of the user according to the current swimming parameter generated by the current swimming of the user and the historical swimming parameter.

In an embodiment, the control module 11 further stores the historical swimming parameter and the historical swimming stroke generated by the historical swimming of the user into the personal database of the user. When the user swims subsequently, the control module 11 compares the current swimming parameter generated by the current swimming of the user with the historical swimming parameter to obtain the change trend of the swimming parameter of the user. For example, in response to a current breaststroke breathing angle of the user is smaller than a historical average value, it is determined that current breaststroke breathing of the user becomes stabler. In response to a current glide duration is longer than a historical average glide duration, it is determined that user's body is more stretched during a current breaststroke glide phase, with smaller resistance during the glide. By comparing the current swimming parameter generated by the current swimming of the user with the historical swimming parameter, it is possible to help the user to track the progress of his or her swimming stroke learning at any time, thereby further expanding the application scenario of the headphone 10.

In summary, in the control method for a headphone according to the present disclosure, when the swimming mode of the headphone 10 is enabled, the swimming parameter of the user wearing the headphone 10 and the swimming stroke of the user during swimming are obtained according to the detection data collected by the sensor module 12, thereby improving the function of the headphone 10 and expanding the application scenario of the headphone 10.

Referring to FIG. 2, FIG. 3, and FIG. 13, in some embodiments, the present disclosure further provides a computer-readable storage medium 200 having a program 202 stored thereon. The program, when executed by a processor, implements the control method according to any of the above embodiments.

For example, the computer program 202, when executed by the processor 20, implements a control method including the following steps 02 to 05.

At step 02, a swimming mode of the headphone is enabled.

At step 03, detection data collected by a sensor module 12 is obtained.

At step 04, a swimming parameter of a user wearing the headphone during swimming is obtained according to the detection data.

At step 05, a swimming stroke of the user during swimming is obtained according to the detection data.

For another example, the computer program 202, when executed by the processor 20, implements a control method including the following step 01.

At step 01, prompt information is issued to guide the user to calibrate an attitude of the headphone 10.

For another example, the computer program 202, when executed by the processor 20, may further implement the control methods in steps 021, 0211, 0213, 0215, 023, 025, 041, 042, 043, 044, 0441, 0442, 0443, 0444, 0445, 051, 053, 055, 06, 07, 071, 073, 075, 077, 08, and 09.

In the computer-readable storage medium 200 of the present disclosure, by decoding video stream data, when the swimming mode of the headphone 10 is enabled, the swimming parameter of the user wearing the headphone 10 and the swimming stroke of the user during swimming are obtained according to the detection data collected by the sensor module 12, thereby improving the function of the headphone 10 and expanding the application scenario of the headphone 10.

In the description of this specification, descriptions with reference to the terms “some embodiments”, “an embodiment”, “some embodiments”, “examples”, “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, those skilled in the art can combine the different embodiments or examples and the features of the different embodiments or examples described in this specification without contradicting each other.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality of” means at least two, such as two, three, etc., unless otherwise specifically defined.

Although embodiments according to the present disclosure have been shown and described, it would be appreciated by those skilled in the art that the above embodiments are illustrative and cannot be construed as a limitation on the present disclosure, and changes, alternatives, modifications, and variations can be made in the embodiments without departing from scope of the present disclosure.

What is claimed is:

1. A control method for a headphone, comprising:
enabling a swimming mode of the headphone;
obtaining detection data collected by a sensor module;
obtaining a swimming parameter of a user wearing the headphone during swimming according to the detection data; and
obtaining a swimming stroke of the user during swimming according to the detection data.

2. The control method according to claim 1, further comprising:
issuing prompt information to guide the user to calibrate an attitude of the headphone.

3. The control method according to claim 2, wherein the sensor module comprises a gyroscope, the detection data comprises a three-axis angular velocity signal detected by the gyroscope, and the control method further comprises:
determining whether the attitude of the headphone is calibrated successfully;
in response to the attitude of the headphone being calibrated successfully, calibrating the three-axis angular velocity signal detected by the gyroscope; and
in response to the attitude of the headphone being not calibrated successfully, disabling the swimming mode of the headphone.

4. The control method according to claim 3, wherein the sensor module further comprises an accelerometer, the detection data comprises a three-axis acceleration signal detected by the accelerometer, and the determining whether the attitude of the headphone is calibrated successfully comprises:
fusing the three-axis acceleration signal at each of a plurality of predetermined time points within a predetermined calibration window, to obtain a resultant acceleration signal at the plurality of predetermined time points;
calculating a maximum value, a minimum value, and an average value of the resultant acceleration signal at the plurality of predetermined time points within the calibration window; and
determining whether the attitude of the headphone is calibrated successfully according to the maximum value, the minimum value, and the average value of the resultant acceleration signal.

5. The control method according to claim 1, wherein the sensor module comprises an accelerometer and a gyroscope, the detection data comprises a three-axis acceleration signal detected by the accelerometer and a three-axis angular velocity signal detected by the gyroscope, and the obtaining the swimming parameter of the user wearing the headphone during swimming according to the detection data comprises:
performing complementary filtering and fusion processing on the three-axis acceleration signal and the three-axis angular velocity signal to obtain a resultant acceleration signal, a resultant angular velocity signal, and quaternion data;
resolving the quaternion data to obtain an attitude angle signal of the headphone; and
determining the swimming parameter according to the resultant acceleration signal, the resultant angular velocity signal, and the attitude angle signal.

6. The control method according to claim 1, wherein the sensor module comprises an accelerometer and a gyroscope, the detection data comprises a three-axis acceleration signal detected by the accelerometer and a three-axis angular velocity signal detected by the gyroscope, and the obtaining the swimming parameter of the user wearing the headphone during swimming according to the detection data comprises:
processing the three-axis acceleration signal and the three-axis angular velocity signal at each of a plurality of predetermined time points within a predetermined swimming window to obtain a resultant acceleration signal, a resultant angular velocity signal, and an attitude angle signal of the headphone at the plurality of predetermined time points within the swimming window; and
determining the swimming parameter according to the resultant acceleration signal, the resultant angular velocity signal, and the attitude angle signal.

7. The control method according to claim 5, wherein the swimming parameter comprises a freestyle breathing angle, the attitude angle signal comprises a roll angle signal, and the determining the swimming parameter according to the resultant acceleration signal, the resultant angular velocity signal, and the attitude angle signal comprises:
obtaining a peak maximum value and a trough average value of the resultant acceleration signal, and a peak maximum value and a trough average value of the resultant angular velocity signal; and
within a first predetermined period, in response to the roll angle signal rising and then falling, and each of the resultant acceleration signal and the resultant angular velocity signal having at least two peak maximum values greater than a first predetermined peak threshold and at least two trough average values smaller than a first predetermined trough threshold, determining a maximum roll angle within the first predetermined period as the freestyle breathing angle.

8. The control method according to claim 5, wherein the swimming parameter comprises a freestyle glide angle, the attitude angle signal comprises a roll angle signal and a pitch angle signal, and the determining the swimming parameter according to the resultant acceleration signal, the resultant angular velocity signal, and the attitude angle signal comprises:
obtaining a peak maximum value and a trough average value of the resultant acceleration signal, and a peak maximum value and a trough average value of the resultant angular velocity signal; and
within a first predetermined period, in response to a fluctuation amplitude of the roll angle signal being smaller than a predetermined first fluctuation threshold, determining an average pitch angle within the first predetermined period as the freestyle glide angle.

9. The control method according to claim 5, wherein the swimming parameter comprises a breaststroke breathing angle, the attitude angle signal comprises a pitch angle signal, and the determining the swimming parameter according to the resultant acceleration signal, the resultant angular velocity signal, and the attitude angle signal comprises:
obtaining a peak maximum value and a trough average value of the resultant acceleration signal, and a peak maximum value and a trough average value of the resultant angular velocity signal; and
within a second predetermined period, in response to each of the resultant acceleration signal, the resultant angular velocity signal, and the pitch angle signal rising, determining a current pitch angle as the breaststroke breathing angle.

10. The control method according to claim 5, wherein the swimming parameter comprises a breaststroke glide duration, the attitude angle signal comprises a pitch angle signal, and the determining the swimming parameter according to the resultant acceleration signal, the resultant angular velocity signal, and the attitude angle signal comprises:
obtaining a peak maximum value and a trough average value of the resultant acceleration signal, and a peak maximum value and a trough average value of the resultant angular velocity signal; and
within a second predetermined period, in response to a fluctuation amplitude of the pitch angle signal being smaller than a predetermined second fluctuation threshold, and the attitude angle signal being within a predetermined breaststroke-glide pitch-angle threshold range, determining a time period during which the pitch angle signal is within the predetermined breaststroke-glide pitch-angle threshold range as the breaststroke glide duration.

11. The control method according to claim 5, wherein the obtaining the swimming stroke of the user wearing the headphone during swimming according to the detection data comprises:
obtaining the number of breathing angles within a predetermined swimming window;
within the swimming window, in response to each of the resultant acceleration signal and the resultant angular velocity signal having at least two peak average values greater than a first predetermined peak threshold, and the number of breathing angles being greater than a predetermined first number threshold, determining the swimming stroke as freestyle; and
within the swimming window, in response to each of the resultant acceleration signal and the resultant angular velocity signal rising, and the number of breathing angles being greater than a predetermined second number threshold, determining the swimming stroke as breaststroke.

12. The control method according to claim 1, further comprising:
obtaining standard parameters corresponding to different standard swimming strokes stored in a database; and
providing a swimming stroke evaluation or a correction suggestion according to the swimming parameter, the swimming stroke of the user, and the standard parameter.

13. The control method according to claim 12, wherein the providing the swimming stroke evaluation or the correction suggestion according to the swimming parameter, the swimming stroke of the user, and the standard parameter comprises:
obtaining a swimming parameter corresponding to a swimming stroke of the user during actual swimming and the standard parameter corresponding to the swimming stroke; and
comparing the swimming parameter corresponding to the swimming stroke with the standard parameter corresponding to the swimming stroke, to determine a swimming stroke standardization degree of the swimming stroke of the user.

14. The control method according to claim 12, wherein the providing the swimming stroke evaluation or the correction suggestion according to the swimming parameter, the swimming stroke of the user, and the standard parameter comprises:
obtaining a swimming parameter corresponding to a swimming stroke of the user during actual swimming and the standard parameter corresponding to the swimming stroke;
comparing the swimming parameter corresponding to the swimming stroke with the standard parameter corresponding to the swimming stroke, to obtain an actual difference; and
providing the correction suggestion according to the actual difference.

15. The control method according to claim 1, further comprising:
storing a historical swimming parameter and a historical swimming stroke generated by historical swimming of the user as historical swimming data into a personal database of the user; and
obtaining a change trend of the swimming parameter of the user according to a current swimming parameter generated by current swimming of the user and the historical swimming parameter.

16. A headphone, comprising:
a sensor module configured to collect detection data; and
a control module in a communication connection with the sensor module and configured to execute a control method for the headphone, the control method comprising:
enabling a swimming mode of the headphone;
obtaining the detection data collected by the sensor module;
obtaining a swimming parameter of a user wearing the headphone during swimming according to the detection data; and
obtaining a swimming stroke of the user during swimming according to the detection data.

17. The headphone according to claim 16, wherein the headphone is a bone conduction headphone.

18. The headphone according to claim 16, wherein the control method further comprises:
issuing prompt information to guide the user to calibrate an attitude of the headphone.

19. The headphone according to claim 18, wherein the sensor module comprises a gyroscope, the detection data comprises a three-axis angular velocity signal detected by the gyroscope, and the control method further comprises:
determining whether the attitude of the headphone is calibrated successfully;
in response to the attitude of the headphone being calibrated successfully, calibrating the three-axis angular velocity signal detected by the gyroscope; and
in response to the attitude of the headphone being not calibrated successfully, disabling the swimming mode of the headphone.

20. A computer-readable storage medium, having a program stored thereon, wherein the program, when executed by a processor, implements a control method for a headphone, the control method comprising:
enabling a swimming mode of the headphone;
obtaining detection data collected by a sensor module;
obtaining a swimming parameter of a user wearing the headphone during swimming according to the detection data; and
obtaining a swimming stroke of the user during swimming according to the detection data.
